(19) United States
(12) Patent Application Publication
(10) Pub. No.: US 2022/0400606 A1
(43) Pub. Date: Dec. 22, 2022

(54) LANDSCAPING EQUIPMENT WITH INCLUDED LASER AND METHODS OF OPERATION

(71) Applicant: Green Industry Innovators, L.L.C., Louisville, OH (US)

(72) Inventors: Steffon Hoppel, Louisville, OH (US); Todd Pugh, Louisville, OH (US)

(73) Assignee: Green Industry Innovators, L.L.C., Louisville, OH (US)

(21) Appl. No.: 17/351,778

(22) Filed: Jun. 18, 2021

(51) Int. Cl. A01D 34/00; A01D 34/43

(52) U.S. Cl. CPC A01D 34/006; A01D 34/43; A01D 2101/00

(57) ABSTRACT

The present disclose provides a combination of a piece of landscaping equipment moveable over a terrain, a laser, and a mounting assembly. The mounting assembly is configured to engage the laser to the piece of landscaping equipment. The laser is selectively operably to emit a laser beam across a portion of terrain that is located in front of the piece of landscaping equipment as the piece of landscaping equipment moves over the terrain. The mounting assembly is operable to adjust a position of the laser relative to the piece of landscaping equipment.

### TECHNICAL FIELD

This disclosure is directed to landscaping equipment. More particularly, this disclosure is directed a device that assists an operator “OP” to correctly align a piece of landscaping equipment. Specifically, this disclosure is directed to an alignment device that is provided on landscaping equipment where the alignment device emits a laser beam, via a laser, to provide an alignment guide to the operator “OP” of the equipment to assist the operator “OP” in maintaining straight lines of travel of the equipment when making a series of progressive passes over a piece of terrain.

### BACKGROUND

In many landscaping and agricultural practices, it is common to have to move a piece of equipment back and forth over a piece of land while performing a task. For example, farmers will drive tractors and combines back and forth while plowing or harvesting. Similarly, landscapers and home owners will push or drive a lawnmower back and forth over a lawn when cutting the grass. When a landscaper or homeowner operates a lawn mower to cut a lawn or an area of grass, the lawn mower tends to bend the grass in a certain direction depending on the direction the lawn mower is traveling when cutting a strip of the lawn or an area of grass. When the lawn mower travels across the lawn in a first direction, the blades of grass tend to bend in a first way and when the mower travels across the lawn in an opposite second direction the blades of grass tend to bend in an opposite second way. The bending of the grass in these two opposite ways produces alternating lighter and darker stripes in the cut lawn. The lighter and darker lawn stripes are created when sunlight reflects differently off the blades of grass that are bent in different ways. Such lawn striping can be seen on golf courses, sport stadiums, and even homeowner's lawns.

The visual effect of striping lawns is aesthetically pleasing but is completely ruined if the operator “OP” of the lawn mower does not consistently maintain his line of travel or the spacing between adjacent lines of travel. The technique of maintaining straight lawn stripes when mowing a lawn or an area of grass is rather difficult. The difficulty arises in a matter of different situations: the size of the lawn or area of grass, the shape of the lawn or area of grass, the undulation and elevation changes provided in the lawn or area of grass, the type of lawn mower, and the types of obstacles or impediments placed in the lawn or area of grass (e.g., trees, flower beds, etc.). Current lawn stripping devices, apparatuses, and kits (e.g., rollers, thick rubber blades, etc.) only provide additional bending of the grass to provide a greater contrast of color when sunlight reflects off the blades of grass.

One conventional technique for creating straight lawn stripes includes a user resorting to aligning their lawn mower to a straight edge, such as a driveway or sidewalk, as a reference for their first lawn stripe to begin their lawn striping process. However, a user may not have the luxury of aligning their lawn mower with a straight edge for starting their lawn striping process. Another conventional technique for creating straight stripes includes aligning the lawn mower with an object in the distance as a reference point. While this technique does provide an adequate starting point for a first straight stripe, a user is not continuously aligned with a reference point and may still create curved and/or uneven stripes after the initial first straight lawn stripe. As such, conventional techniques and striping devices do not provide a lawn mower user with the capabilities of creating straight lawn stripes throughout the grass cutting process without extensive use and practice of cutting and/or mowing lawns.

### SUMMARY

The Applicant has recognized that the conventional technology and current pose problems in the field of this invention to allow for continuous alignment between each mowing stripe for producing straighter lawn stripes. Therefore, an improvement is needed.

In one aspect, an exemplary embodiment of the present disclosure may provide a combination of a piece of landscaping equipment moveable over a terrain, a laser, and a mounting assembly. The mounting assembly is configured to engage the laser to the piece of landscaping equipment. The laser is selectively operably to emit a laser beam across a portion of terrain that is located in front of the piece of landscaping equipment as the piece of landscaping equipment moves over the terrain.

This exemplary embodiment or another exemplary embodiment may further provide that the mounting assembly is operable to adjust a position of the laser relative to the piece of landscaping equipment. This exemplary embodiment or another exemplary embodiment may further provide that the mounting assembly permits vertical adjustment of the laser relative to the piece of landscaping equipment. This exemplary embodiment or another exemplary embodiment may further provide that the mounting assembly permits lateral adjustment of the laser relative to a longitudinal axis of the piece of landscaping equipment, wherein the longitudinal axis extends between a front end and a rear end of the piece of landscaping equipment. This exemplary embodiment or another exemplary embodiment may further provide that the mounting assembly permits longitudinal adjustment of the laser relative to a longitudinal axis of the piece of landscaping equipment, wherein the longitudinal axis extends between a front end and a rear end of the piece of landscaping equipment. This exemplary embodiment or another exemplary embodiment may further provide that the piece of landscaping equipment is a zero-turn lawn mower. This exemplary embodiment or another exemplary embodiment may further provide that the mounting assembly secures the laser to a mower deck provided on the zero-turn lawn mower. This exemplary embodiment or another exemplary embodiment may further provide that the mounting assembly secures the laser to a main body of the zero-turn lawn mower that is disposed above the mower deck. This exemplary embodiment or another exemplary embodiment may further provide that the mounting assembly has a mounting bracket and an arm, wherein the arm is moveably disposed on the mounting bracket, and wherein the laser is moveably disposed on the arm. This exemplary embodiment or another exemplary embodiment may further provide that a mounting bracket has a wall that defines a first portion and a second portion; wherein the first portion and the second portion are operably engaged at a bend formed in the wall of the bracket. This exemplary embodiment or another exemplary embodiment may further provide that the first portion is disposed on the piece of landscaping equipment; and wherein the first portion is selectively adjustable on the piece of landscaping equipment for adjusting the laser relative to the piece of landscaping equipment. This exemplary embodiment or another exemplary embodiment may further provide that the second portion and the arm operably engage to one another; and wherein the arm is selectively adjustable on the second portion for adjusting the laser relative to the piece of landscaping equipment. This exemplary embodiment or another exemplary embodiment may further provide that the second portion permits vertical adjustment of the arm relative to the second portion. This exemplary embodiment or another exemplary embodiment may further provide that the second portion permits longitudinal adjustment of the arm relative to the second portion. This exemplary embodiment or another exemplary embodiment may further provide that the arm permits rotational adjustment of the laser relative to the arm.

In another aspect, an exemplary embodiment of the present disclose may provide a device includes a mounting bracket, an arm, and a laser. The mounting bracket has a wall that defines a first portion and a second portion. The first portion and the second portion are operably engaged at a bend that is formed in the wall of the bracket. The first portion is operably engaged to a lawn mower. The arm has a first end and a second end that opposes the first end, and the arm is moveably provided on the second portion of the mounting bracket at the second end of the arm. The laser is moveably provided on the first end of the arm, wherein the laser emits a laser beam to provide an alignment reference along a cut stripe of lawn.

In yet another aspect, an exemplary embodiment of the present disclosure may provide a device. The device includes a mounting bracket, an arm, a laser, and at least one fastener. The mounting bracket has a wall that defines a first portion and a second portion. The first portion and the second portion are operably engaged at a bend formed in the wall of the bracket. The first portion is operably engaged to a lawn mower. The first portion has at least one oblong opening that extends through the first portion, and the at least one oblong opening has a first end and a second end that opposes the first end. The second end of the at least one oblong opening is disposed closer to the second portion near the bend. The arm has a first end and a second end that opposes the first end, and the arm is moveably provided on the second portion of the mounting bracket at the second end of the arm. The laser is moveably provided on the first end of the arm, and the laser emits a laser beam to provide an alignment reference along a cut stripe of lawn. The at least one fastener is disposed through the at least one oblong opening and has a first end and a second end that includes a head. The at least one fastener operably engages the first portion of the mounting bracket to the lawn mower to maintain the mounting bracket to the lawn mower.

In yet another aspect, an exemplary embodiment of the present disclosure may provide a device. The device includes a mounting bracket, an arm, a laser, and at least one fastener. The mounting bracket has a wall that defines a first portion and a second portion. The first portion and the second portion are operably engaged at a bend formed in the wall of the bracket. The first portion is operably engaged to a lawn mower. The first portion has at least one oblong opening that extends through the first portion. The at least one oblong opening has a first end and a second end that opposes the first end, and the second end of the at least one oblong opening is disposed closer to the second portion near the bend. The arm has a first end and a second end that opposes the first end, and the arm is moveably provided on the second portion of the mounting bracket at the second end of the arm. The laser is moveably provided on the first end of the arm, and the laser emits a laser beam to provide an alignment reference along a cut stripe of lawn. The at least one fastener is disposed through the at least one oblong opening and has a first end and a second end that includes a head. The at least one fastener operably engages the first portion of the mounting bracket to the lawn mower to maintain the mounting bracket to the lawn mower. In addition, the laser is disposed on a mower deck of the lawn mower opposite a discharge chute provided on the mower deck. The laser is in line with a terminal edge of a blade opposite to the discharge chute provided on the mower deck.

In another aspect, an exemplary embodiment of the present disclosure may provide a method for improving alignment for lawn striping, the method comprising the step of providing an alignment device on a lawn mower; emitting a laser beam, via a laser provided on the alignment device, onto a lawn of grass; adjusting the laser such that the laser beam is aligned parallel to a cut stripe of grass of the lawn of grass; and following the laser beam for lawn striping the lawn of grass.

This exemplary embodiment or another exemplary embodiment may further provide the step of aligning the laser beam with a sidewall of a mower deck provided on the lawn mower. This exemplary embodiment or another exemplary embodiment may further provide the step of adjusting the laser vertically relative to a vertical axis of the piece of landscaping equipment via a mounting assembly. This exemplary embodiment or another exemplary embodiment may further provide the step of adjusting the laser laterally relative to a longitudinal axis of the piece of landscaping equipment via a mounting assembly. This exemplary embodiment or another exemplary embodiment may further provide the step of adjusting the laser longitudinally relative to a longitudinal axis of the piece of landscaping equipment via a mounting assembly.

### BRIEF DESCRIPTION OF THE SEVERAL VIEWS OF THE DRAWINGS

Sample embodiments of the present disclosure are set forth in the following description, are shown in the drawings and are particularly and distinctly pointed out and set forth in the appended claims.

FIG. 1 is a top plan view of a zero turn mower that includes the alignment device in accordance with the present disclosure, wherein the alignment device is provided on the mower deck of the lawn mower in a location opposite the discharge chute, and is being used by an operator “OP” to guide the movement of the mower. The laser is line with the outermost edge of the mower deck of the zero turn lawn mower.

FIG. 1A is a top plan view of the zero turn lawn mower that includes the alignment device in accordance with the present disclosure, wherein the alignment device is provided on the mower deck of the lawn mower in a location opposite the discharge chute, and is being used by an operator “OP” to guide the movement of the mower. The laser is provided inside of the outermost edge of the mower deck of the zero turn lawn mower.

FIG. 2 is a perspective view of an alignment device in accordance with an aspect of the present disclosure shown on a part of a mower deck of a lawn mower. A laser of the alignment device is illustrated emitting a laser beam for the purpose of aligning the lawn mower during a cutting operation.

FIG. 3 is a top plan view of the alignment device provided on the mower deck of the lawn mower illustrated in FIG. 2.

FIG. 4 is a second side elevation view of the alignment device provided on the mower deck taken along line 4-4 of FIG. 3.

FIG. 5 is a first side elevation view of the alignment provided on the mower deck taken along line 5-5 of FIG. 3.

FIG. 6 is a cross-section of the alignment device provided on the mower deck of the lawn mower taken along line 6-6 of FIG. 4.

FIG. 7 is a first side elevation view of the alignment device shown in use and illustrating possible pivotal motion of the laser and of an arm upon which the laser is mounted.

FIG. 8A is a top plan view of a zero turn mower that includes the alignment device mounted in an alternative location on the body of the mower a distance vertically above the mower deck and wherein the alignment device is being used by the operator “OP” to guide the movement of the mower.

FIG. 8B is a top plan view of a zero turn mower that includes the alignment device mounted in a further alternative location on the body of the lawn mower a distance vertically above the mower deck and adjacent to the discharge chute, and wherein the alignment device is being used by the operator “OP” to guide the movement of the mower.

FIG. 9 is a top plan view of another alignment device provided on the mower deck of the lawn mower.

FIG. 10 is a second side elevation view of the alignment device provided on the mower deck taken along line 10-10 of FIG. 9.

FIG. 11 is a first side elevation view of the alignment device provided on the mower deck taken along line 11-11 of FIG. 9.

FIG. 12 is a perspective view of another alignment device in accordance with an aspect of the present disclosure shown on a part of a mower deck of a lawn mower. A laser of the alignment device is illustrated emitting a laser beam for the purpose of aligning the lawn mower during a cutting operation.

FIG. 13 is a top plan view of the alignment device illustrated in FIG. 12 provided on the mower deck of the lawn mower.

FIG. 14 is a flow chart illustrating an exemplary method of improving for a lawn striping operation utilizing the alignment device in accordance with the present disclosure.

Similar numbers refer to similar parts throughout the drawings.

### DETAILED DESCRIPTION

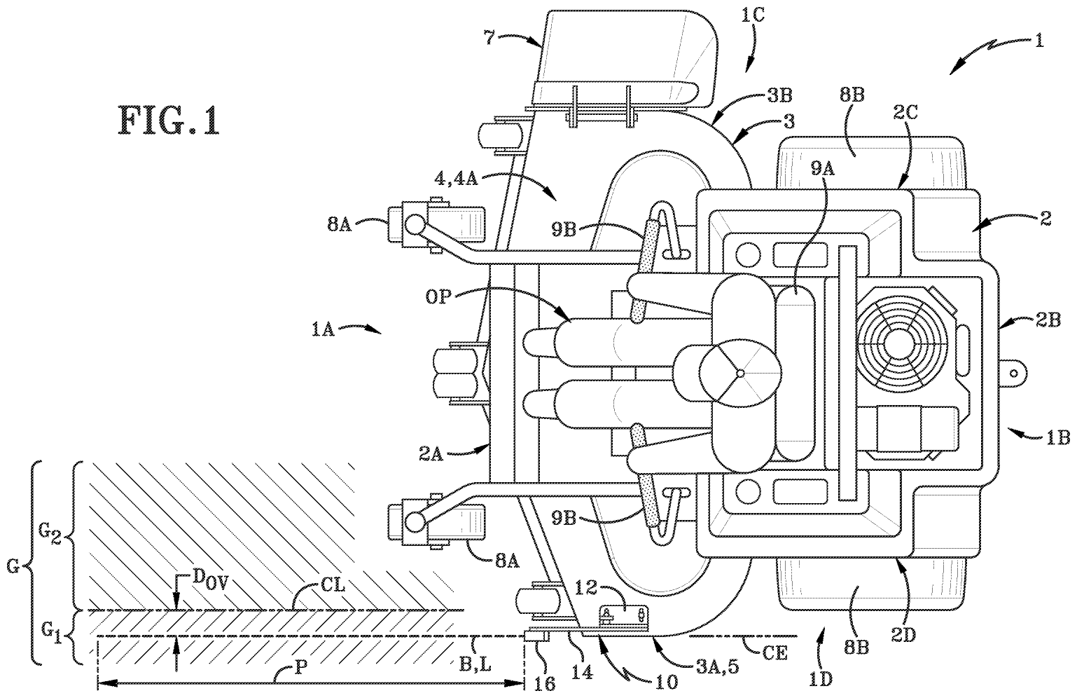

FIG. 1 illustrates a lawn mower, which is generally indicated by the reference number 1. It will be understood that the illustrated lawn mower 1 is exemplary only and any type of lawn mower is contemplated to be represented by the illustrated device. Such lawn mowers considered suitable herein include push lawn mowers, self-propelled lawn mowers, riding lawn mowers, sit-on zero-turn lawn mowers, stand-on zero-turn lawn mowers, tractor-pulled lawn mowers, and other similar lawn mowers for the purpose of cutting grass.

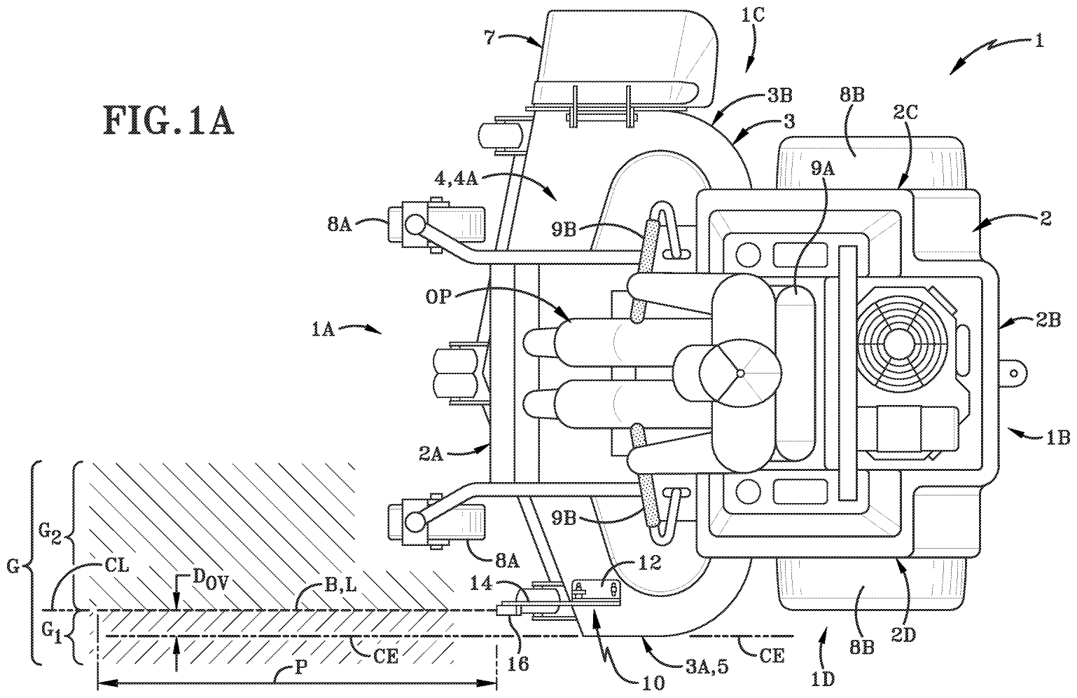

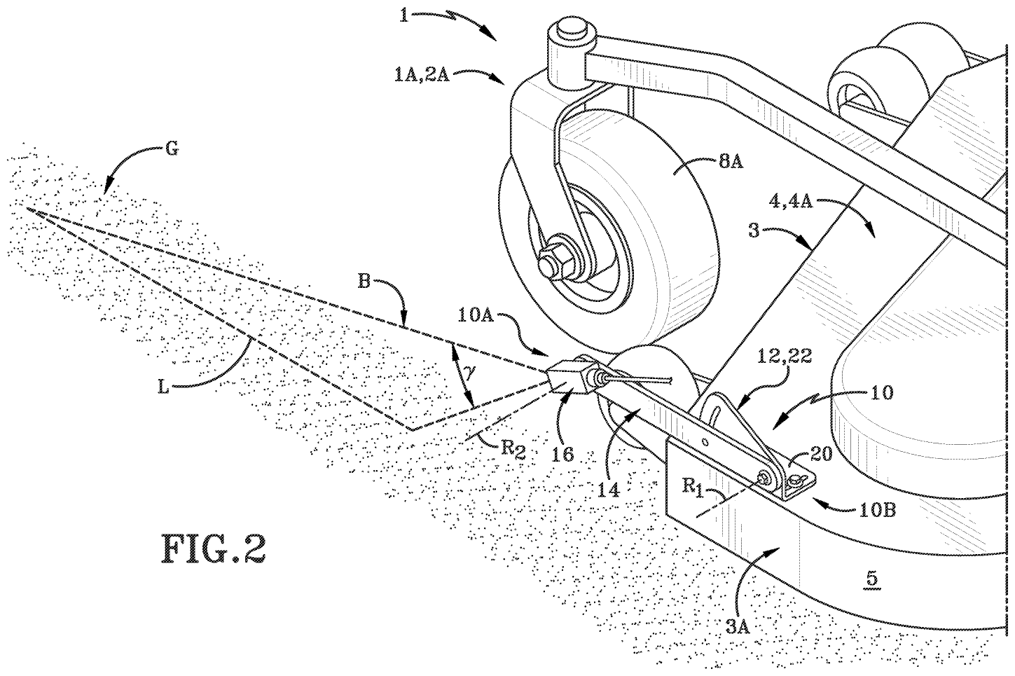

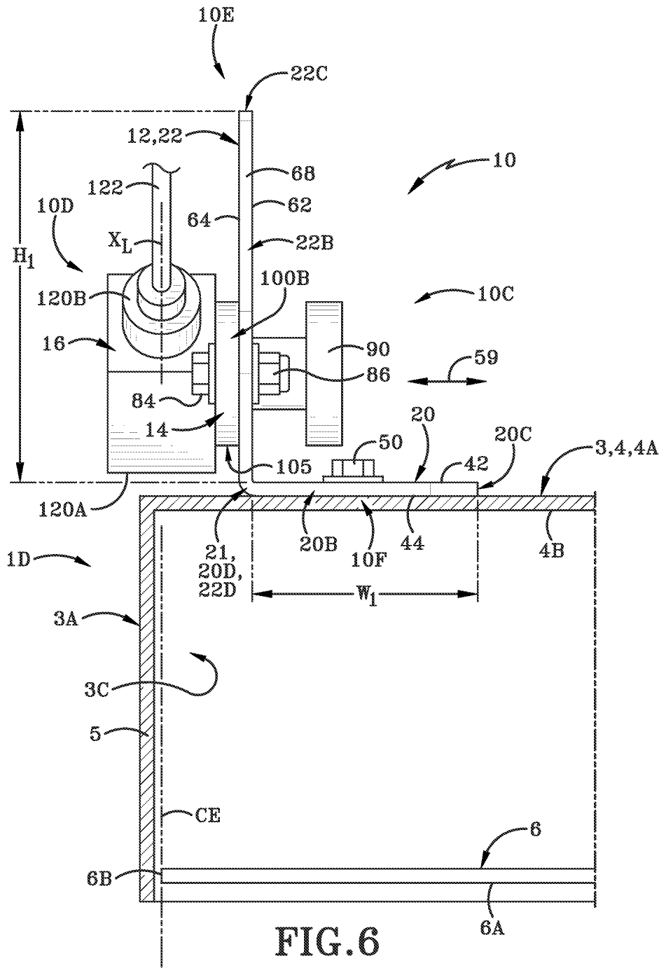

As illustrated in FIG. 1, lawn mower 1 that has a front end 1A, a rear end 1B opposite to the front end 1A, a first side 1C, and a second side 1D opposite to the first side 1C. The lawn mower 1 includes a main body 2 that has a front end 2A, a rear end 2B opposite to the front end 2A, a first side 2C, and a second side 2D opposite to the first side 2C. Lawn mower 1 includes a mower deck 3 that is disposed beneath the main body 2 of the lawn mower 1 and extends between the left and second sides 1C, 1D of the lawn mower 1. The mower deck 3 has a closed end 3A and a discharge end 3B. The mower deck 3 has an upper wall 4 that extends between the closed end 3A and the discharge end 3B and has an outer surface 4A and an inner surface 4B (illustrated in FIG. 6). The mower deck 3 also includes a sidewall 5 (illustrated in FIG. 2) that extends from the upper wall 4 and is disposed about the perimeter of the mower deck 3.

Referring now to FIG. 6, the mower deck 3 also includes a plurality of blades 6 that is provided on the inner surface 4B of the upper wall 4 for the purpose of cutting a lawn of grass “G”. Each blade of the plurality of blades 6 is rotatably mounted to the upper wall 4 such that the plurality of blades 6 may cut a lawn of grass “G”. Still referring to FIG. 6, each blade of the plurality of blades 6 includes at least one leading edge 6A for cutting and discharging the blades of grass. Each blade of the plurality of blades 6 includes a first terminal edge 6B and a second terminal edge (not illustrated) at each end of the leading edge 6A. The first terminal edge 6B and second terminal edge on a cutting blade of the plurality of cutting blades 6 defines the limits of the cutting capability for the cutting blade. Such cutting blades of the plurality of blades 6 may be any suitable length depending upon the size, shape, and configuration of the mower deck 3. The mower deck 3 also includes a discharge chute 7 at the discharge end 3B to discharge grass clippings caused by the plurality of blades 6 from under the mower deck 3 during the mowing operation.

In addition, the main body 2 includes a set of front wheels 8A and a set of rear wheels 8B where the mower deck 3 is disposed between the set of front wheels 6 and the set of rear wheels. The main body 2 also includes a user-operating seat 9A that is disposed above the mower deck 3. The user-operating seat 9A is configured to allow an operator “OP” “OP” of the lawn mower 1 to operate the lawn mower 1 in an ergonomic position. The main body 2 also includes a set of steering bars 9B that is disposed above the mower deck 3 and is located adjacent to the user-operating seat 9A. The set of steering bars 9B are configured to allow the operator “OP” “OP” of the lawn mower 1 to control the steering and speed of the lawn mower 1 during operating of said lawn mower 1.

As illustrated in FIG. 1, in accordance with an aspect of the present disclosure, the lawn mower 1 is provided with an alignment device 10 that is able to be used by an operator “OP” to improve the alignment of the mower 1 relative to an edge of a stripe of previously cut grass. The improved alignment afforded by the alignment device 10 helps the operator “OP” to reduce the overlap of previously cut strips of grass and thereby more consistently stripe a lawn. As illustrated, the alignment device 10 is provided on the outer surface 4A of the upper wall 4 of the mower deck 3 exterior to the plurality of blades 6 disposed inside of a cutting chamber 3C defined by the mower deck 3. In the illustrated embodiment, the alignment device 10 is also provided at the closed end 3A of the mower deck 3. It will be understood that other components that are not particularly relevant to the alignment device 10 and its operation have been omitted from FIGS. 2-7 for clarity of illustration only. The components of the alignment device 10 are moveably disposed on the lawn mower 1 and are moveably disposed to one another. Such movement of the alignment device 10 is also described in more detail below.

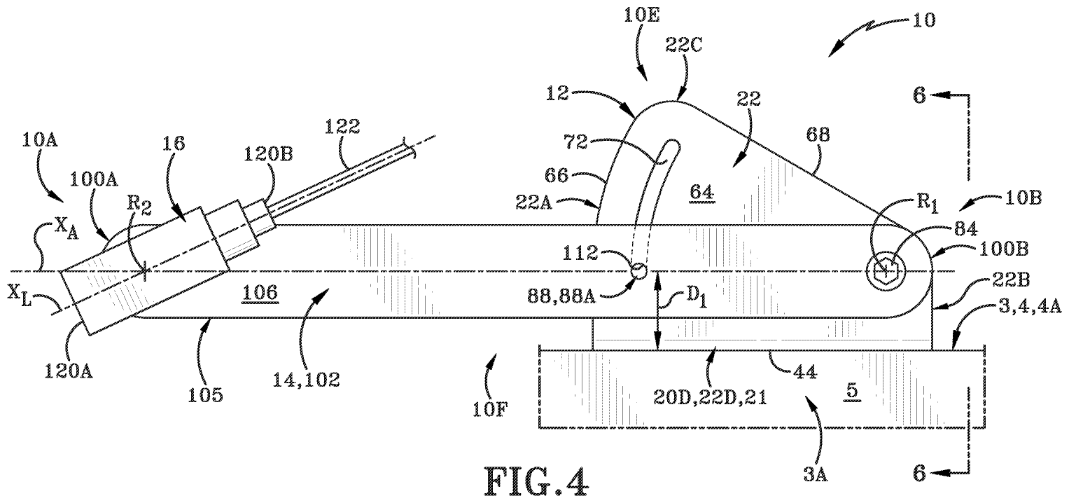

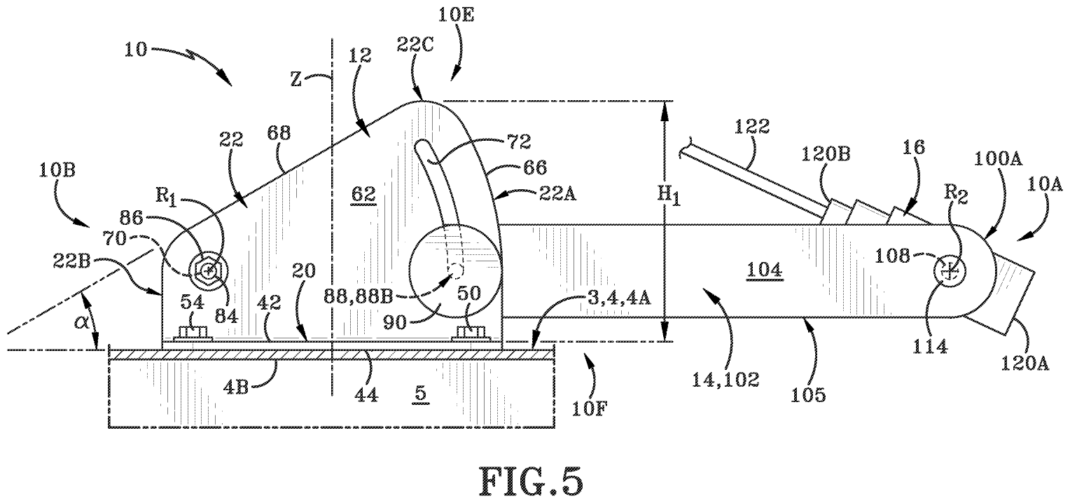

Referring to FIGS. 2 through 6, alignment device 10 will now be described in greater detail. As best shown in FIGS. 4 and 5, the alignment device 10 includes a mounting bracket 12, an arm 14 that is operably engaged to the mounting bracket 12, and a laser 16 that is operably engaged to the arm 14. Each of these components will be discussed in detail hereafter.

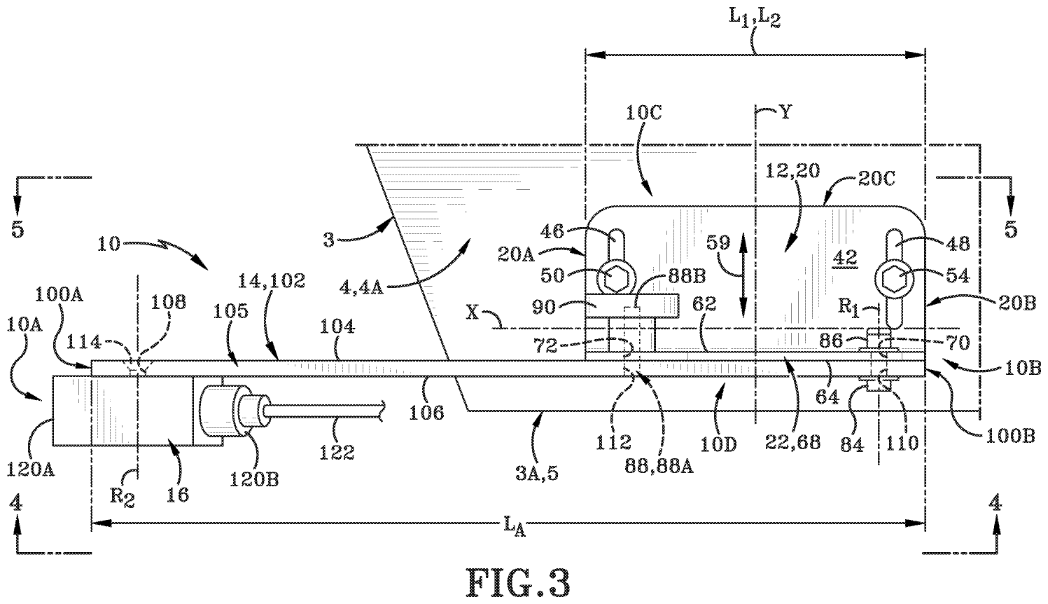

Alignment device 10 generally has a front end 10A, a rear end 10B that opposes the front end 10A, a first side 10C, a second side 10D that opposes the first side 10C, a top end 10E, and a bottom end 10F that opposes the top end 10E. The bottom end 10D faces downwardly toward the mower deck 3 and the plurality of blades. The alignment device 10 defines a longitudinal axis “X” (FIG. 3) that extends from the front end 10A to the rear end 10B, a transverse axis “Y” that extends from the first side 10C to the second side 10D (FIG. 3), and a vertical axis “Z” (FIG. 5) that extends from the top end 10E to the bottom end 10F.

As best seen in FIG. 6, the mounting bracket 12 is a reverse L-shape when viewed from the front of the lawn mower 1. Mounting bracket 12 has a first portion 20 and a second portion 22. The first portion 20 and the second portion 22 are continuous with each other such that the first portion 20 is integral with the second portion 22 along a bend 21. In the illustrated embodiment, the first portion 20 and the second portion 22 are orthogonal to one another. In other exemplary embodiments (not shown herein) the mounting bracket may be differently configured. For example, a second portion may be bent to any other suitable angle relative to a first portion. Examples of other suitable configurations for the mounting bracket are that a second portion may be bent relative to a first portion at about 45 degrees, or from about 45 degrees up to about 90 degrees. It will also be understood that the mounting bracket may include fewer than two portions or more than two portions.

While the first portion 20 is integral with the second portion 22 along the bend 21, a first and second portion may be operably engaged in other suitable ways. Examples of operably engaging a first portion to a second portion include attaching, connecting, affixing, welding, mounting, and other suitable examples of operably engaging a first portion to a second portion.

As best seen in FIG. 3, the first portion 20 is generally rectangular in shape when viewed from above. As best seen in FIG. 4, the second portion 22 is generally a truncated-triangle in shape. Referring to FIGS.3 through 6, first portion 20 has a front end 20A disposed near the front end 10A of the alignment device 10, a rear end 20B disposed near the rear end 10B of the alignment device 10, a first side 20C disposed near the bend 21, and a second side 20D disposed near the second side 10D of the alignment device. As illustrated in FIG. 2, the first portion 20 is of a first length “L₁” that extends from the front end 20A to the rear end. As illustrated in FIG. 6, the first portion 20 also has a first width “W₁” that extends from the first side 20C to the bend 21. The first portion 20 also include a top surface 42 that faces towards the top end 10E of the alignment device 10 and a bottom surface 44 that faces towards the bottom end 10F of the alignment device 10. As illustrated in FIGS. 5 and 6, the bottom surface 44 contacts an upper wall 4 of the mower deck 3 when the mounting bracket 12 is engaged with the mower deck 3.

As illustrated in FIG. 3, the first portion 20 of the mounting bracket 12 defines a first opening 46 and a second opening 48 that extend from the top surface 42 through to the bottom surface 44. Each of the first opening 46 and second opening 48 is an elongated slot that extends generally parallel to the transverse axis “Y” of the alignment device 10 and between first side 20C and second side 20D of the first portion 20. First opening 46 and second opening 48 are located a distance longitudinally apart from one another where the first opening 46 is proximate to the front end 20A of the first portion 20 and the second opening 48 is proximate to the rear end 20B of the first portion 20. Each of the first and second openings 46, 48 provides communication between the top surface 42 and the bottom surface 44 of the first portion 20. The first opening 46 is sized and configured to receive a first fastener 50 therethrough such that the first fastener 50 passes through the first opening 46 and into an aperture (not shown) defined in the upper wall 4 of mower deck 3 to secure the mounting bracket 12 to the mower deck 3. Similarly, the second opening 48 is sized and configured to receive a second fastener 54 therethrough such that the second fastener 54 passes through the second opening 48 and into an aperture (not shown) defined in the upper wall 4 of the mower deck 3 to secure the mounting bracket 12 to the mower deck 3.

In addition, each of the first and second fasteners 50, 54 may operably engages a nut (not illustrated) to mechanically hold and maintain the mounting bracket 12 to the mower deck 3. The first and second fasteners 50, 54 may be any suitable types of fastener with associated components that can hold and maintain the mounting bracket 12 to the mower deck 3 or the lawn mower 1. In one exemplary embodiment, a fastener may be a screw where a first end of the fastener mechanically engages a mower deck of a lawn mower via an attachment point located on the mower deck of the lawn mower to mechanically hold and maintain the mounting bracket to the mower deck.

Furthermore, the first and second fasteners 50, 54 may also define any suitable configuration that allows a user to tighten and/or loosen the first and second fasteners 50, 54. In one exemplary embodiment, a head on a fastener may include a recess that is shaped and/or configured to match the shape and/or configuration a driving tool (e.g., a screwdriver, wrench, etc.) Examples of recess shapes provided in a head of a fastener include cross-shaped, bar-shaped, square-shaped, hexagonal shape, star-shaped, and other suitable recess shapes provided in a head of a first or second fastener. In another exemplary embodiment, a head on a fastener may include a plurality of ridges disposed circumferentially about the head of fastener that allows the user to tighten or loosen either the fastener (e.g., a thumb screw). Such configuration may eliminate the need of a tool to tighten or loosen a fastener during adjustment of an alignment device.

While the first portion 20 includes first and second openings 46, 48, any suitable number of openings may be provided on a first portion of a mounting bracket. In addition, the selected number of openings provided on a first portion may have an equal amount of fasteners.

In the illustrated embodiment, the first and second openings 46, 48 provided on the first portion 20 are oblong-shaped. The oblong-shaped openings provided on the first portion 20 allow the mounting bracket 12 to be selectively adjustable relative to the mower deck 3 along the first and second openings 46, 48 while still being held and maintained by the first and second fasteners 50, 54. Such adjustability of the mounting bracket 12 relative to the mower deck 3 is illustrated by arrows 59. In order to adjust the mounting bracket 12 relative to the mower deck 3 while the first and second fasteners 50, 54 are disposed inside of the first portion 20 and mower deck 3, a user of the alignment device 10, such as a landscaper, may loosen the first and/or second fasteners 50, 54 such that the first and second fasteners 50, 54 disengage the top surface 42 of the first portion 20 to the mounting bracket 12. Upon disengagement, the mounting bracket 12 becomes selectively adjustable relative to the mower deck 3 along the first and second openings 46, 48 while still being held and maintained by the first and second fasteners 50, 54. The selectable adjusting configuration between the mower deck 3 and the mounting bracket 12 allows a user to adjust the mounting bracket 12 relative to the mower deck 3 when selecting a suitable distance of overlap between each stripe of grass cut by the plurality of blades 6 provided on the lawn mower 1. The adjustment of the mounting bracket 12 also adjusts the position of the laser beam “B” provided by laser 16 along the transverse axis “Y” between the first side 10C and the second side 10D of the alignment device 10, which is described in more detail below.

As illustrated in FIG. 5, the second portion 22 of the mounting bracket 12 has a front end 22A disposed near the front end 10A of the alignment device 10, a rear end 22B disposed near the rear end 10B of the alignment device 10, a top end 22C disposed near the top end 10E of the alignment device 10, and a bottom end 22D disposed near the bottom end 10F of the alignment device 10. The second portion 22 is of a second length “L2” that extends from the front end 22A to the rear end 22B. Referring to FIG. 6, the second portion 22 also defines a tapered-height “Hi” that extends from the bend 21 to the top end 22C. The front end 22A of the second portion 22 has a curvilinear surface 66 (FIGS. 4 and 5) that extends upwardly from the bend 21 to the top end 22C of the second portion 22. As illustrated in FIG. 5, the height “Hi” of the second portion 22 tapers from the front end 22A in a direction moving longitudinally towards the rear end 22B such that the height at the front end 22A is greater than the height at the rear end 22B. The curvilinear surface 66 at the front end 22A of the second portion 22 also orients a top surface 68 that is disposed at the top end 22C of the second portion 22 and extends from the front end 22A of the second portion 22 to the rear end 22B of the second portion 22. The top surface 68 is disposed at an angle a measured relative to the top surface 42 of the first portion 20. As illustrated in FIG. 5, the angle a of top surface 68 that is measured relative to the top surface 42 of the first portion 20 is of about 30 degrees. It will be understood that top surface 68 may be oriented at any suitable angle based upon the length of the curvilinear surface 66 disposed along the front end 22A of the second portion 20.

The second portion 22 also include a left surface 62 that faces towards the first side 10C of the alignment device 10 and a right surface 64 that faces towards the second side 10D of the alignment device 10. As illustrated in FIG. 5, the right surface 64 contacts and is engaged with the arm 14.

As illustrated in FIG. 5, the second portion 22 defines a third opening 70 and a fourth opening 72 that extend between the left surface 62 and right surface 64. The third opening 70 is disposed proximate to the rear end 22B of the second portion 22, and the fourth opening 72 is disposed proximate to the front end 22A of the second portion 22. In the illustrated embodiment, the third opening 70 is a circular hole and the fourth opening 72 is an arcuate slot. Similar to the first and second openings 46, 48 of the first portion 20, the fourth opening 72 of the second portion 22 is also a slot. However, the fourth opening 72 of the second portion 22 extends between the top and bottom ends 22C, 22D and defines a curvilinear shape. The arcuate slot has a radius of curvature that is complementary to the radius of curvature of the curvilinear front end 22A.

As illustrated in FIG. 4, the arm 14 has a first end 100A, a second end 100B directly opposite to the first end 100A, a longitudinal axis “X_{A}” that extends from the first end 100A and through the second end 100B, a main wall 102, an arm length “L_{A}” that extends between the first end 100A and the second end 100B (shown in FIG. 3), and a circumferential wall 105 disposed about the perimeter of the main wall 102 that extends between the first and second ends 100A, 100B. Each of the first end 100A and the second end 100B of the arm 14 includes rounded edges. The arm 14 has a left surface 104 that faces the first side 10C of the alignment device 10 and a right surface 106 that faces the second side 10D of the alignment device 10. The left surface 104 is parallel to the right surface 106 and they oppose one another. The arm length “L_{A}” is greater than the first and second length “L₁”, “L₂” of the first and second portions 20, 22. The arm length “L_{A}” of the arm 100 extends beyond the mower deck 3 such that the mower deck 3 does not inhibit or block the operation of the laser 16 during use. The operation of the laser 16 is provided in more detail below.

As illustrated in FIGS. 3 through 5, the arm 14 defines a first opening 108, a second opening 110, and a third opening 112. The first opening 108 of the arm 14 is disposed between the first end 100A and the second end 1006 of the arm 14 and is disposed proximate to the first end 100A of the arm 14. The second opening 110 of the arm 14 is disposed between the second end 100B and the first opening 108 of the arm 14 and is proximate to the second end 1006 of the arm 14. The third opening 112 of the arm is disposed between the first end 100A of the arm 14 and the second opening 110 and is proximate to the second end 100B of the arm 14. Each of the first opening 108, second opening 110, and third opening 112 extends entirely through the arm 14 from the left surface 104 to the right surface 106 such that the left surface 104 and right surface 106 are in communication at the first opening 108, second opening 110, and third opening 112.

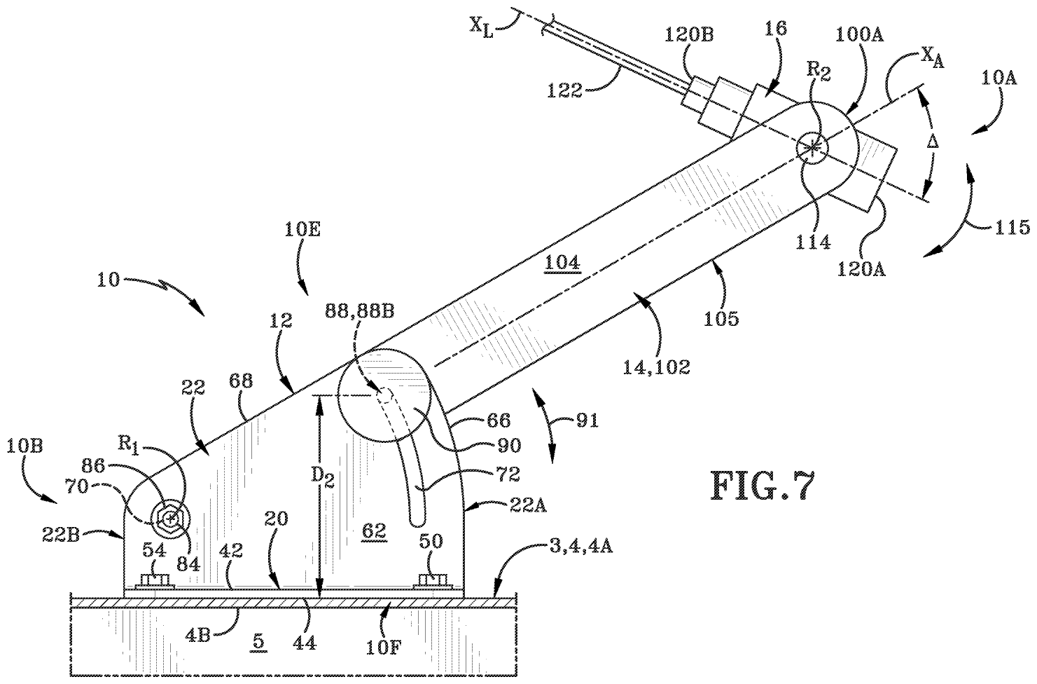

The third opening 70 of the second portion 22 and the second opening 110 of the arm 14 is sized and configured to receive a third fastener 84 such that the third fastener 84 passes through the third opening 70 of the second portion 22 and the second opening 110 of the arm to secure the arm 14 and the mounting bracket 12 to one another. The third fastener 84 engages a nut 86 to mechanically secure the arm 14 and the mounting bracket 12 to one another. As illustrated in FIGS. 3 and 7, the arm 14 is capable of pivoting about a first axis of rotation “Ri” that extends along a shaft of the third fastener 84. The third fastener 84 may be any suitable fastener with associated components that can hold and maintain the arm 14 to the mounting bracket 12. In one exemplary embodiment, a fastener may be a screw where a first end of the fastener mechanically engages an arm via an attachment point located on the arm to mechanically hold and maintain the arm to the mounting bracket.

The fourth opening 72 of the second portion 22 and the third opening 112 of the arm 14 is sized and configured to receive a fourth fastener 88 such that the fourth fastener 88 passes through the fourth opening 72 and secures the arm 14 and the mounting bracket 12 to one another. The fourth fastener 88 defines a first end 88A that is passed through the fourth opening 72 and is disposed in the third opening 112 of the arm 14 to secure the fourth fastener 88 to the arm 14. The fourth fastener 88 also includes a second end 88B that is opposite to the first end 88A. The fourth fastener 88 includes a thread (not illustrated) that extends from the second end 88B of the fourth fastener 88 to a location between the first and second ends 88A, 88B of the fourth fastener 88. A release knob 90 is releasably engaged with the second end 88B of the fourth fastener 88. The release knob 90 includes a threading (not illustrated) that is complementary to the thread of the fourth fastener 88 such that the release knob 90 is releasably engaged with the fourth fastener 88. When the release knob 90 is tightened to the fourth fastener 88 by a user in a first direction and abuts the left surface 62 of the second portion 22, the release knob 90 prevents movement of the arm 14 relative to the mounting bracket 12 as illustrated in FIG. 6. When the release knob 90 is loosened from the fourth fastener 88 by the user in a second opposite direction and is away from the left surface 62 of the second portion 22, the arm 14 pivots on the third fastener 84 between the top and bottom ends 10E, 10F of the alignment device 10 relative to the mounting bracket 12 as illustrated in FIG. 6. During the pivoting movement, the fourth fastener 72 and the release knob 90 rotate with the arm 14 along the fourth opening 88 between the top and bottom ends 10E, 10F of the alignment device 10. The rotation of the arm 14 is illustrated by the arrows denoted 91 in FIG. 7. The moveable configuration between the mounting bracket 12 and the arm 14 allows a user to manually adjust the angle of the arm 14 relative to the mounting bracket 12 when selecting a suitable height for the laser 16 to cast a suitable length of laser beam “B” onto a lawn of grass for striping alignment purposes, as will be described later herein.

In the illustrated embodiment, the arm 14 has a first position, which is illustrated in FIGS. 2-6, and a second position, which is illustrated in FIG. 7. In the first position, the arm 14 is disposed parallel to the top surface 42 of the first portion 20. As illustrated in FIG. 4, the fourth fastener 88 is disposed at a first distance “D₁” that is measured relative to the outer surface 4A of the mowing deck 3 when the arm 14 is disposed in the first position. In the first position, the fourth fastener 88 is disposed proximate to the bottom end 10F of the alignment device 10. The arm 14 transitions from a first position to a second position when the release knob 90 is disengaged and away from the left surface 62 of the second portion 22 via the user asserting a rotational force in the counter-clockwise direction on the release knob 90 to loosen the release knob 90. Upon disengagement, the arm 14 pivots on the third fastener 84 and moves upwardly away from first portion 20 of the mounting bracket 12 and towards the top surface 68 of the second portion 22 via the user asserting a pulling force on the arm 14 and/or the release knob 90 in an upward direction towards the top end 10E. As illustrated in FIG. 7, the arm 14, along with the fourth fastener 88 and the release knob 90, are disposed at a second distance “D₂” that is measured relative to the outer surface 4A of the mowing deck 3 when the arm 14 is disposed in the second position. In the illustrated embodiment, the second distance “D₂” is greater than the first distance “D₁”. In addition, the fourth fastener 88 and the release knob 90 transition with the arm 14 when the arm 14 transitions from a first position to a second position. In one exemplary embodiment, the arm 14 may remain in the first position depending on the determination made by the user when the user is operating a lawn mower that is equipped with an alignment device.

As illustrated in FIG. 4, the laser 16 has a first end 120A, a second end 120B that is opposite to the first end 120A, a longitudinal axis “X_{L}” that extends from the first end 120A to the second end 120B, and an attachment point (not illustrated) that is disposed between the first end 120A and the second end 120B of the laser 16 proximate to the first end 120A of the laser 16. In addition, the laser 16 may be powered in various ways to emit a laser beam “B.” In one exemplary embodiment, a laser may be powered by connecting a main lead, as denoted in 122 in FIGS. 2-7, from the laser to a power source stored on the lawn mower (e.g., a mower battery) in order to power the laser for emitting a laser beam. In another exemplary embodiment, a laser may be powered via an internal power source stored in the laser (e.g., an internal battery) in order to power the laser for emitting a laser beam.

As illustrated in FIGS. 1 and 2, the laser 16 emits the laser beam “B” onto the lawn of grass “G” during operation of the lawn mower 1 displaying a laser line “L”. The laser beam “B” is emitted at angle y from the laser 16 measured from the laser 16 to the lawn of grass “G.” As illustrated in FIGS. 1, 2, 8A, and 8B, the laser beam “B” is emitted at a beam length “P” that is measured from first end 120A of the laser 16 to an opposing end of the laser beam “B”. The beam length “P” of the laser beam “B” that is emitted by the laser 16 may be any suitable length that provides a suitable alignment reference for striping a lawn of grass. Examples of suitable lengths for a beam length of a laser beam emitted by a laser includes at least five feet, between five feet to about twenty-five feet, about twenty-five feet, and any other suitable beam length of a laser beam emitted by a laser. In addition, any conventional laser device may be used for the laser 16 in the alignment device 10, such as any conventional solid-state laser. In addition, the selected laser 16 must be able to emit a suitable length of laser beam such that the laser beam is visible during daylight and visible on a lawn of grass.

As illustrated in FIGS. 3, 5, and 7, the alignment device 10 includes a fifth fastener 114. The first opening 108 of the arm 14 and the attachment point of the laser 16 is sized and configured to receive and house the fifth fastener 114 to secure the arm 14 and the laser 16 to one another. The fifth fastener 114 passes through the first opening 108 of the arm 14 and is disposed within attachment point of the laser 16. As illustrated in FIG. 7, the laser 16 pivots on the fifth fastener 114 in which the laser 16 rotates about a second axis of rotation “R2” defined by the fifth fastener 114 when the laser 16 is manipulated by the user, which is described in more detail below. The rotation of the laser 16 on the fifth fastener 114 is illustrated by the arrows denoted 115 in FIG. 7. The second axis of rotation “R2” is disposed orthogonal to the longitudinal axis “X_{A}” of the arm 14 and is disposed parallel to the transverse axis “Y” of the alignment device 10 due to the placement of the fifth fastener 114. As illustrated in FIG. 7, the longitudinal axis “X_{L}” of the laser 16 is oriented at an angle Δ that is measured relative to the longitudinal axis “X_{A}” of the of the arm 14. Examples of suitable angles for an angle Δ of a longitudinal axis of a laser that is measured relative to a longitudinal axis of an arm include a range measured between about 10 degrees to about 45 degrees.

While the alignment device 10 may be provided on the mower deck 3 of the lawn mower 1 as illustrated in FIGS. 1-7, alternative alignment devices may be provided on other suitable locations that may be available on the lawn mower 1. As such, the positioning of the alignment device 10 as illustrated in FIG. 1 is exemplary only in which the alignment device 10 may be disposed at different position along the mower deck 3 or at different position along the body of the lawn mower 1.

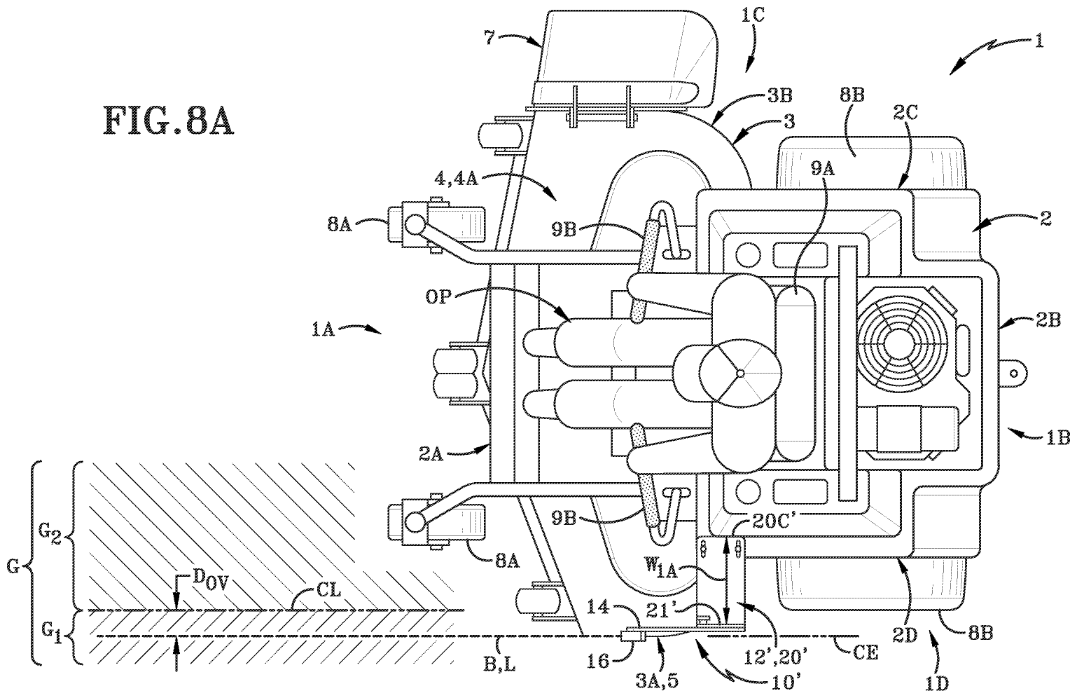

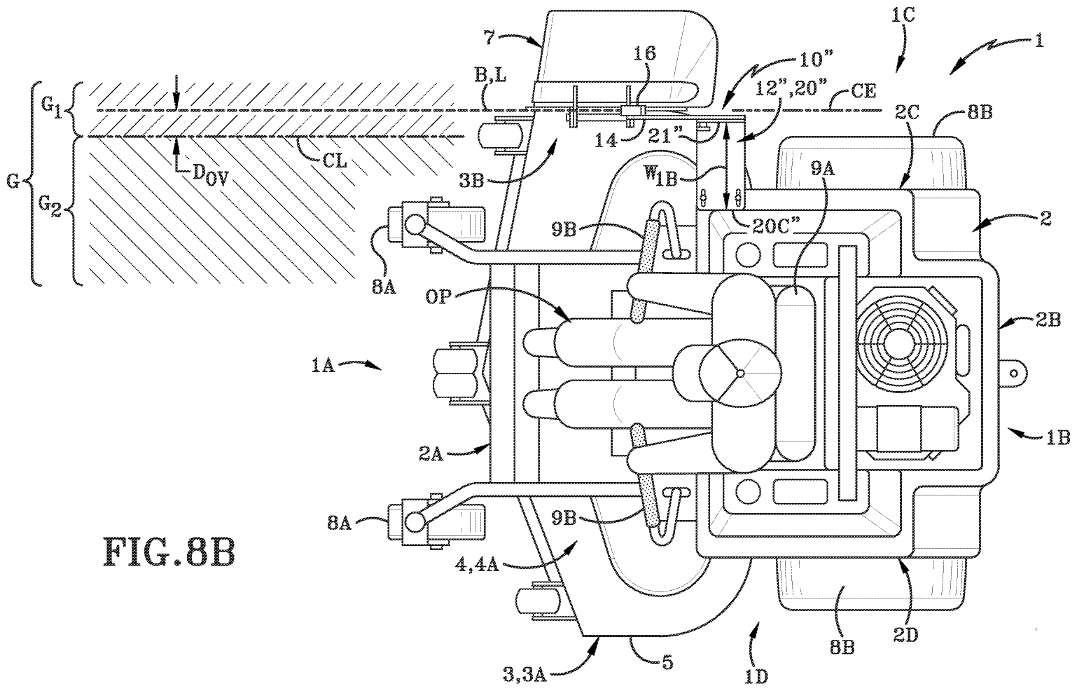

As illustrated in FIG. 8A, an alternative alignment device 10′ may be provided on the main body 2 of the lawn mower 1. In the alternative embodiment, the alternative alignment device 10′ is disposed above the mower deck 3 and opposite to the discharge chute 7. The alignment device 10′ illustrated in FIG. 8A includes an alternative mounting bracket 12′ that has a first portion 20′. The first portion 20′ defines an alternative first width “W1A” that extends from the first side 20C′ of the first portion 20′ to the bend 21′. The first width “W_{1A}” of the first portion 20′ provided in the mounting bracket 12′ is greater than the first width “W₁” of the first portion 20 provided in the mounting bracket 12 illustrated in FIGS. 1-7. The greater width defined by the first portion 20′ in the alignment device 10′ is provided due to the body of the lawn mower 1 being narrower than the mower deck 3. Such greater width of the alignment device 10′ positions the laser line “L”, emitted by laser 16, in line with the outermost edge of the mower deck 3 at the closed end 3A to provide a suitable overlap distance between a cut piece of grass and an uncut piece of grass, which is described in more detail below.

As illustrated in FIG. 8B, another alternative alignment device 10″ may be provided on the body of the lawn mower 1, which is disposed above the mower deck 3 and adjacent to the discharge chute 7. Similar to the alignment device 10′ illustrated in FIG. 8A, the alignment device 10″ includes an alternative mounting bracket 12″ that has a first portion 20″. The first portion 20″ defines an alternative first width “W_{1B}” that extends from the first side 20C″ of the alignment device 10″ to the bend 21″. The first width “WEB” of the first portion 20″ provided in the mounting bracket 12″ is greater than the first width “W” of the first portion 20 provided in the mounting bracket 12 illustrated in FIGS. 1-7 and equal to the first width “W_{1A}” of the alternative alignment device 10′ illustrated in FIG. 8A. The greater width defined by the first portion 20″ in the alignment device 10″ is provided due to the body of the lawn mower 1 being narrower than the mower deck 3. However, the alignment device 10″ illustrated in FIG. 8B is different than the alignment device 10′ illustrated in FIG. 8A due to configuration of the mounting bracket 12″ being different than the mounting bracket 12′.

Having now described the alignment device 10 and its components disposed therein, a method of operation of the alignment device 10 is provided below.

As illustrated in FIG. 1, a user is operating the lawn mower 1 while cutting a lawn of grass “G” where the alignment device 10 is provided on the mower deck 3 of the lawn mower 1. In the illustrated embodiment, the first portion 20 of the mounting bracket 12 abuts the mower deck 3 and the first and second fasteners 50, 54 are disposed in the mower deck 3 and the mounting bracket 12 to hold and maintain the mounting bracket 12 to the mower deck 3 of the lawn mower 1. Upon installation of the alignment device 10 to the mower deck 3 and prior to the user cutting a lawn of grass, the user may adjust the mounting bracket 12, the arm 14, and/or the laser 16 accordingly.

To adjust the arm 14, the user applies a rotational force against the release knob 90 in a counter-clockwise direction to loosen the knob 90 from on the fourth fastener 88. Once the release knob 90 is loosened, the arm 14 is able to pivot about the first axis of rotation “R₁” that extends along the shaft of the third fastener 84. The user may apply a pulling force to the release knob 90 or along a portion of the arm 14, where the pulling force is in a direction moving from the bottom end 10F of the alignment device 10towards the top end 10E of the alignment device 10. Such a pulling force applied by the user pivots the arm 14 from a first position (shown in FIG. 5) to a second position (shown in FIG. 7).

In the first position (shown in FIG. 5), the arm 14 is disposed parallel to the top surface 42 of the first portion 20. In addition, the fourth fastener 88 is disposed at a first distance “D₁” measured from the outer surface 4A of the mower deck 3 when the arm 14 is disposed in the first position. In the first position, the fourth fastener 88 is disposed proximate a lower end of the fourth opening 72 towards the bottom end 10F of the alignment device 10. The arm 14 transitions from the first position to the second position when the release knob 90 is loosened and a pulling force is applied to arm 14 to move the arm 14 upwardly along the fourth opening 72 towards an upper end thereof. As illustrated in FIG. 7, the arm 14, along with the fourth fastener 88 and the release knob 90, are disposed at a second distance “D₂” measured from the outer surface 4A of the mower deck 3 when the arm 14 is disposed in the second position. In the illustrated embodiment, the second distance “D₂” is greater than the first distance “D₁”. In addition, the fourth fastener 88 and the release knob 90 translate (or move) in unison with the arm 14 when the arm 14 translates (or moves) from the first position to the second position. Furthermore, the laser 16 may be turned from an “OFF” position to an “ON” position. When laser 16 is in the “ON” position the laser 16 emits the laser beam “B”. As shown in FIG. 2, the laser beam “B” shines on the grass for a distance in front of the lawn mower 1. The operator “OP” will adjust the angle of the laser 16 or the angle of the arm 14 so that the laser beam “B” shines for a distance longitudinally forwardly away from a front end of the lawn mower 1 as will be described in detail hereafter.

Once the user selects a suitable second position for the arm 14, the user holds the arm 14 in place while he/she asserts tightens the release knob 90 to lock the arm in that selected second position. As such, the user applies a rotational force in the clockwise direction to tighten the release knob 90 to the fourth fastener 88 and to reengage the left surface 62 of the second portion 22 of the mounting bracket 12. Such reengagement between the release knob 90 and the mounting bracket 12 applies a pulling force to the arm 14 to cinch the arm 14 to the mounting bracket 12 such that the arm 14 is maintained in the user's selected second position. The user may omit the adjustment of the arm 14 in which the arm 14 remains in the first position during the grass cutting process.

To adjust the laser 16, the user may loosen the fifth fastener 114 from the laser 16 by asserting a counter-clockwise direction on the fifth fastener 114 via a driving tool (e.g., a screwdriver, wrench, etc.) or by hand depending on the type of fasteners used for fifth fastener 114. Such loosening of the fifth fastener 114 allows the user to pivot the laser 16 on the fifth fastener 114 for adjusting the placement of the laser beam “B”. Once the fifth fastener 114 is loosened, the user may apply a rotational force against the laser 16 in a counter-clockwise direction about the second axis of rotation “R₂” such that the laser 16 pivots about the fifth fastener 114 and is disposed at the angle Δ. Once the user rotates the laser 16 to a desired angle Δ, the user then applies an opposing rotational force on the fifth fastener 114. Specifically, the user applies a rotational force in the clockwise direction to tighten the fifth fastener 114 into the laser 16 such that the laser 16 remains fixed to the desired angle Δ selected by the user and displays a beam line “L.”

Once the arm 14 and/or the laser 16 is/are adjusted, the mounting bracket 12 may be adjusted by the user applying a rotational force against the first and second fasteners 50, 54 via a driving tool (e.g., a screwdriver, wrench, etc.) or by hand depending on the type of fasteners used for first and second fasteners 50, 54. The user applies a rotational force to each of the first and second fasteners 50, 54 in a counter-clockwise direction to loosen the each of the first and second fasteners 50, 54 from the mounting bracket 12. The user may loosen the first and second fasteners 50, 54 to a suitable location such that each head of the first and second fasteners 50, 54 disengages the top surface 42 of the first portion 20 while still being disposed inside the mower deck 3. Once the first and second fasteners 50, 54 are disengaged, the mounting bracket 12 is selectively adjustable along the transverse axis “Y” between the respective ends of the first and second openings 46, 48. As illustrated in FIGS. 1, 8A, and 8B, the adjustment of the mounting bracket 12 between the respective ends of the first opening 46 and the second opening 48 allows the user to select an overlap distance “D_{OV}” between a cut grass portion “G₁” and an uncut grass portion “G₂”. The overlap distance “D_{OV}” selected by the user will be referenced by the laser beam “B” emitted by the laser 16. Once the user selects a desired overlap distance “D_{OV}”, the user then applies an opposing rotational force on the first and second fasteners 50, 54 to tighten the first and second fasteners 50, 54 into the mounting bracket 12 and the mower deck 3. Such tightening of the first and second fasteners 50, 54 allows first and second fasteners 50, 54 to reengage the top surface 42 of the first portion 20 such that the mounting bracket 12 remains fixed to the desired position and overlap distance “D_{OV}” selected by the user.

As illustrated in FIG. 6, the laser beam “B” emitted from the laser 16 is aligned with sidewall 5 at the closed end 3A of the mower deck 3, which is aligned approximately with the outermost edge of the mower deck 3 to provide a suitable overlap distance “D_{OV}.” In other words, the laser line “L” emitted by the laser 16 is aligned approximately with a cutting edge “CE” at the closed end 3A of the mower deck 3 to prevent the operator “OP” from missing uncut grass “G₂” due to the plurality of blades 6 being subjected to the cut grass portion “G₁”. In other exemplary embodiments, the overlap distance “D_{OV}” of the mounting bracket 12 may be varied based on the user's preferences of overlapping prior cut grass. In one exemplary embodiment, the user may adjust a mounting bracket to a first overlap distance such that a laser beam emitted by a laser is line with the terminal edges of a cutting blade of the plurality of cutting blades to maximize the total cutting width of a mower deck. In another exemplary embodiment, the user may adjust a mounting bracket to second, different overlap distance such that a laser beam emitted by a laser is disposed closer to a discharge chute that is provided on a mower deck. As such, the laser beam emitted by a laser is disposed proximal to the terminal edges of a cutting blade of the plurality of cutting blades provided in the mower deck. In comparison, the first overlap distance is greater than the second overlap distance.

In another exemplary embodiment, the laser beam “B” emitted from the laser 16 may be aligned on the edge of the cut grass portion “G₁” such that the laser beam “B” is emitted inside the cutting capabilities of the plurality of blades 6. As illustrated in FIG. 1A, the laser line “L” and the cut line “CL” share the same axis where the operator “OP” maintains the laser line “L” on the cut line “CL” while using the alignment device 10 during a lawn cutting process. As such, the cutting edge “CE” is disposed on the cut grass portion “G₁” during the law cutting process to provide the operator “OR” with a suitable overlap “D_{OV}” provided by the mounting bracket 12. The position of the alignment device 10 may be disposed closer to the discharge end 3B as compared to the position of the alignment device 10 illustrated in FIG. 1A.

In the alternative embodiments illustrated in FIGS. 8A and 8B, the user may adjust the associated components included in the alternative alignment devices 10′, 10″ similarly to the associated components included in the alignment device 10 illustrated in FIGS. 1-7. In the alternative alignment devices 10′, 10″, however, the user may adjust the associated components included in the alternative alignment devices 10′, 10″ while remaining on the lawn mower 1 and/or operating the lawn mower 1. In other words, the user is able to adjust the associated components included in the alternative alignment devices 10′, 10″ “on-the-fly” without disengaging the power take-off (“PTO”) switch of the mower deck 3 and/or stepping off the lawn mower 1. As illustrated in FIG. 8A, the alignment device 10′ is disposed on main body 2 above the mower deck 3 and on the same level of the user-operating seat 9A and the steering bars 9B. Similarly, the alignment device 10″ illustrated in FIG. 8B is also disposed on the main body 2 above the mower deck 3 and on the same level of the user-operating seat 9A and the steering bars 9B. As such, the alternative alignment devices 10′, 10″ may provide the user with a quicker adjustment setup for adjusting the associated components on the alternative alignment devices 10′, 10″.

In other exemplary embodiments, the adjustment of the mounting bracket 12, the arm 14, and/or the laser 16 may be repeated more than once prior to the user cutting a lawn of grass. In addition, the adjustment of the mounting bracket 12, the arm 14, and the laser 16 may be performed in an order different from the order stated herein. Furthermore, the adjustments of the mounting bracket 12, the arm 14, and/or the laser 16 may be omitted based on the user's preferences when using the alignment device 10 on the lawn mower 1.

The inclusion of the laser 16 on the alignment device 10 is considered advantageous at least because the laser 16 provides an alignment reference for the user when the user is cutting a lawn of grass. The laser beam “B” emitted by the laser 16 provides a cutting line that the user may follow while cutting a lawn of grass. As such, the cutting line provides the user with a suitable lawn striping design such that each stripe in the lawn of grass is oriented parallel to each other in a straight, linear orientation. The laser beam “B” emitted by the laser 16 provides the laser line “L” to the user when performing certain striping design on a lawn of grass, such as diagonal striping patterns, cross striping patterns, or zigzag striping patterns, or other design patterns that include straight and/or linear cutting patterns. In addition, the laser beam “B” of the laser 16 provides a suitable length of overlap between the cut grass and uncut grass such that a portion of the uncut grass is not left uncut by a blade in the plurality of blades during cutting process of the lawn of grass. The overlap between the cut grass and uncut grass portions may be adjusted by moving the first portion 20 of the mounting bracket 12 along the transverse axis “Y.” Furthermore, the laser beam ^{“R}₂” of the laser 16 may be oriented at any angle along the second axis of rotation “B” based on the size, shape, and/or configuration of the lawn of grass to provide an optimal cutting line for the user.

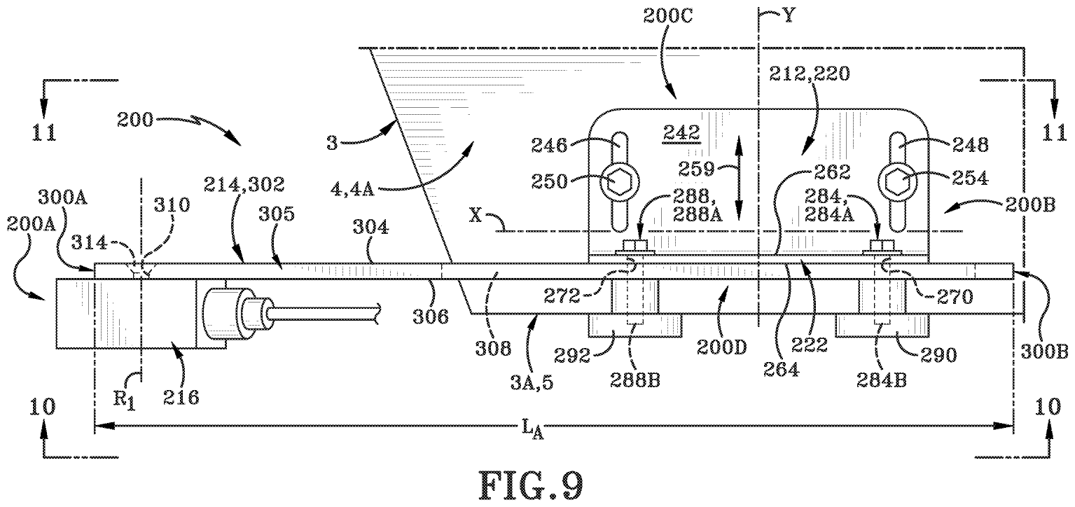

FIGS. 9 through 11 illustrate another alignment device 200 that is similar to alignment device 10 illustrated in FIGS. 1-7, except as detailed below. Alignment device 200 includes a mounting bracket 212, an arm 214, and a laser 216.

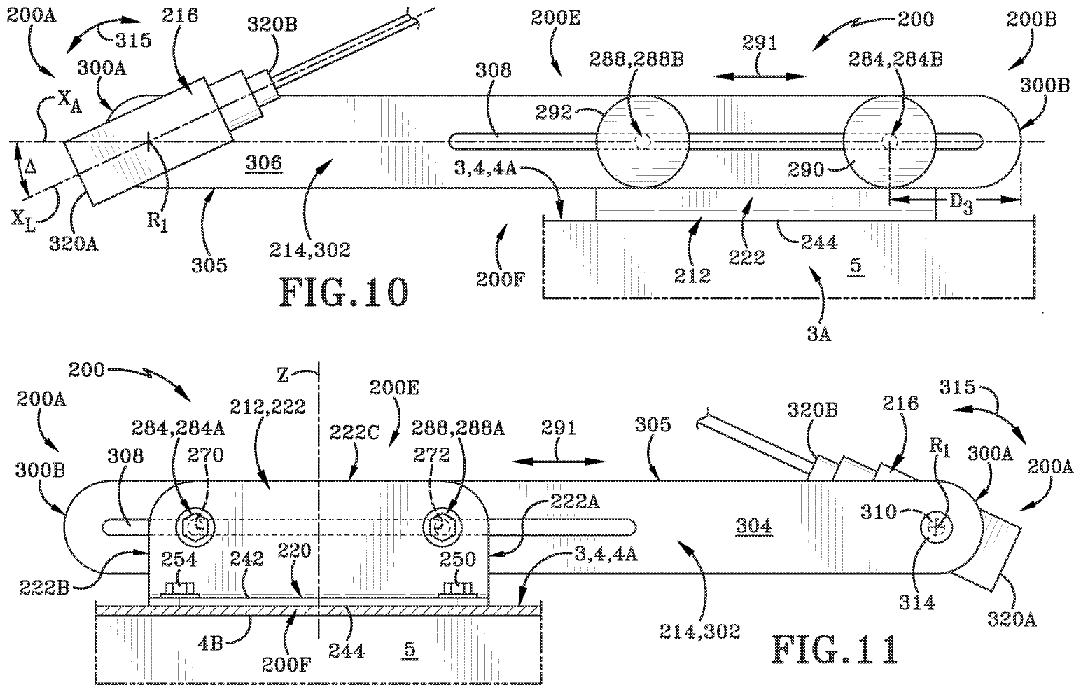

Alignment device 200 generally has a front end 200A, a rear end 200B that opposes the front end 200A, a first side 200C, a second side 200D that opposes the first side 200C, a top end 200E (shown in FIGS. 10 and 11), and a bottom end 200F (shown in FIGS. 10 and 11) that opposes the top end 200E. Alignment device 200 defines a longitudinal axis “X” (FIG. 9) that extends from the front end 200A to the rear end 200B, a transverse axis “Y” that extends from the first side 200C to the second side 200D (FIG. 9), and a vertical axis “Z” (FIG. 11) that extends from the top end 200E to the bottom end 200F.

As illustrated in FIG. 9, the mounting bracket 212 is similar to mounting bracket 12 of the alignment device 10 such that the mounting bracket 212 includes a first portion 220 and a second portion 222. As illustrated in FIG. 9, the first portion 220 of the mounting bracket 212 defines a first opening 246 and a second opening 248 similar to the first and second openings 46, 48 of alignment device 10. Each of the first opening 246 and second opening 248 is an elongated slot that extends generally parallel to the transverse axis “Y” of the alignment device 210 and between first side 220C and second side 220D of the first portion 220. First opening 246 and second opening 248 are located a distance longitudinally apart from one another. Each of the first and second openings 246, 248 provides communication between a top surface 242 and a bottom surface 244 (see FIG. 11) of the first portion 220. The first opening 246 is sized and configured to receive a first fastener 250 therethrough such that the first fastener 250 passes through the first opening 246 and into an aperture (not shown) defined in the upper wall 4 of mower deck 3 to secure the mounting bracket 212 to the mower deck 3. Similarly, the second opening 248 is sized and configured to receive a second fastener 254 therethrough such that the second fastener 254 passes through the second opening 248 and into an aperture (not shown) defined in the upper wall 4 of the mower deck 3 to secure the mounting bracket 212 to the mower deck 3.

In addition, each of the first and second fasteners 250, 254 may operably engage a nut (not illustrated) to mechanically hold and maintain the mounting bracket 212 to the mower deck 3. The first and second fasteners 250, 254 may be any suitable types of fastener with associated components that can hold and maintain the mounting bracket 212 to the mower deck 3 or the lawn mower 1. In one exemplary embodiment, a fastener may be a screw where a first end of the fastener mechanically engages a mower deck of a lawn mower via an attachment point located on the mower deck of the lawn mower to mechanically hold and maintain the mounting bracket to the mower deck.

In the illustrated embodiment, the first and second openings 246, 248 provided on the first portion 220 are oblong-shaped. The oblong-shaped openings provided on the first portion 220 allow the mounting bracket 212 to be selectively adjustable relative to the mower deck 3 along the first and second openings 246, 248 while still being held and maintained by the first and second fasteners 250, 254. Such adjustability of the mounting bracket 212 relative to the mower deck 3 is illustrated by arrows 259. In order to adjust the mounting bracket 212 relative to the mower deck 3 while the first and second fasteners 250, 254 are disposed inside of the first portion 220 and mower deck 3, a user of the alignment device 10, such as a landscaper, may loosen the first and/or second fasteners 250, 254 such that the first and second fasteners 250, 254 disengage the top surface 242 of the first portion 220 to the mounting bracket 212. Upon disengagement, the mounting bracket 212 becomes selectively adjustable relative to the mower deck 3 along the first and second openings 246, 248 while still being held and maintained by the first and second fasteners 250, 254. The selectable adjusting configuration between the mower deck 3 and the mounting bracket 212 allows a user to adjust the mounting bracket 212 relative to the mower deck 3 when selecting a suitable distance of overlap between each stripe of grass cut by the plurality of blades 6 provided on the lawn mower 1. The adjustment of the mounting bracket 212 also adjusts the position of the laser beam “B” provided by laser 16 along the transverse axis “Y” between the first side 200C and the second side 200D of the alignment device 10, which is described in more detail below.

As illustrated in FIG. 11, the second portion 222 of the mounting bracket 212 has a front end 222A disposed near the front end 200A of the alignment device 200, a rear end 222B disposed near the rear end 200B of the alignment device 200, a top end 222C disposed near the top end 200E of the alignment device 200, and a bottom end 222D disposed near the bottom end 200F of the alignment device 200. The second portion 222 of alignment device 200 is similar to the second portion 22 of the alignment device 10. However, the second portion 22 of alignment device 200 is generally rectangular and is similar in shape to the first portion 220 of alignment device 200. In addition, the second portion 222 defines a third opening 270 and a fourth opening 272 that extend between a left surface 262 of the second portion 222 and a right surface 264 of the second portion 222. The third opening 270 is disposed proximate to the rear end 200B of the second portion 222, and the fourth opening 272 is disposed proximate to the front end 222A of the second portion 222. In the illustrated embodiment, the third and fourth opening 270, 272 are both circular holes, which is different compared to the third and fourth openings 70, 72 of alignment device 10.

Each of the third and fourth openings 270, 272 of the second portion 222 of the mounting bracket 212 is sized and configured to receive a first and second nut 273, 274. The first nut 273 is disposed at the third opening 270 where the first nut 273 engages the second portion 222 and a washer. The second nut 274 is disposed at the fourth opening 272 where the second nut 274 engages the second portion 222 and a washer. The first and second nut 273, 274 may engage the second portion 222 of the mounting bracket 212 in any suitable arrangement. Examples of first and second nuts engaging a second portion of a mounting bracket include attaching, adhering, affixing, connecting, fixing, joining, mounting, press-fitting, riveting, welding, and any other suitable ways of engaging first and second nuts with a second portion of a mounting bracket.

As illustrated in FIGS. 9 through 11, the arm 214 has a first end 300A, a second end 300B directly opposite to the first end 300A, a longitudinal axis “XA” that extends from the first end 300A and through the second end 300B, a main wall 302, an arm length “LA” that extends between the first end 300A and the second end 300B, and a circumferential wall 305 disposed about the perimeter of the main wall 302 that extends between the first and second ends 300A, 300B. Each of the first end 300A and the second end 300B of the arm 214 includes rounded edges. The arm 214 has a left surface 304 that faces the first side 200C of the alignment device 200 and a right surface 306 that faces the second side 200D of the alignment device 200. The left surface 304 is parallel to the right surface 306 and they oppose one another.

In the illustrated embodiment, the arm 214 defines a slot 308 and an opening 310 different than that of the arm 14 of alignment device 10. The slot 308 extends along the longitudinal axis “X_{A}” of the arm 214 from the second end 300B to a location between the first and second ends 300A, 300B of the arm 214. The opening 310 is disposed at the first end 300A of the arm 214 and is generally circular. The slot 308 and the opening 310 also extend entirely through the arm 214 from the left surface 304 to the right surface 306 such that the left surface 304 and right surface 306 are in communication at the slot 308 and the opening 310.

The third opening 270 of the second portion 222 and the slot 308 of the arm 214 is sized and configured to receive a third fastener 284 such that the third fastener 284 passes through the third opening 270 and slot 308 and secures the arm 214 and the mounting bracket 212 to one another via the first nut 273 and a washer. The third fastener 284 defines a first end 284A that is passed through the slot 308 and is disposed in the first nut 273 that abuts the left surface 262. The third fastener 284 also includes a second end 284B that is opposite to the first end 284A. The third fastener 284 includes a thread (not illustrated) that extends from the second end 284B of the third fastener 284 to a location between the first and second ends 284A, 284B of the third fastener 284. A first release knob 290 is releasably engaged with the second end 284B of the third fastener 284. The first release knob 290 includes a threading (not illustrated) that is complementary to the thread of the third fastener 284 such that the first release knob 290 is releasably engaged with the third fastener 284. In addition, the fourth opening 272 of the second portion 222 and the slot 308 of the arm 214 is sized and configured to receive a fourth fastener 288 such that the fourth fastener 288 passes through the slot 308 and secures the arm 214 and the mounting bracket 212 to one another via the second nut 274. The fourth fastener 288 defines a first end 288A that is passed through the slot 308 and is disposed in the second nut 274. The fourth fastener 288 also includes a second end 288B that is opposite to the first end 288A. The fourth fastener 288 includes a thread (not illustrated) that extends from the second end 288B of the fourth fastener 288 to a location between the first and second ends 288A, 288B of the fourth fastener 288. A second release knob 292 is releasably engaged with the second end 288B of the fourth fastener 288. The second release knob 292 includes a threading (not illustrated) that is complementary to the thread of the fourth fastener 288 such that the second release knob 292 is releasably engaged with the fourth fastener 288.

When the first and second release knobs 290, 292 are tightened to the third and fourth fasteners 284, 288 by a user in a first direction and abuts the right surface 306 of the arm 214, the first and second release knobs 290, 292 prevent movement of the arm 214 relative to the mounting bracket 212. When the first and second release knobs 290, 292 are loosened from the third and fourth fasteners 284, 288 by the user in a second opposite direction and is away from the right surface 306 of the second portion 222, the arm 214 linearly moves along on the third and fourth fasteners 284, 288 inside the slot 308 between the front and rear ends 200A, 200B of alignment device 200 relative to the mounting bracket 212 (illustrated in FIGS. 10 and 11). During the linear movement, the third and fourth fasteners 284, 288 and the first and second release knobs 290, 292 remain stationary when the arm 214 linear moves between the front and rear ends 200A, 200B of alignment device 200. The linear movement of the arm 214 is illustrated by the arrows denoted 291 in FIGS. 10 and 11. The moveable configuration between the mounting bracket 212 and the arm 214 allows a user to manually adjust the distance of the arm 214 relative to the mounting bracket 212 when selecting a suitable distance for the laser 216 to cast a suitable length of laser beam “B” onto a lawn of grass “G” for striping alignment purposes, as will be described later herein.

The arm 214 has a first position (not illustrated) and a second position, which is illustrated in FIGS. 10 and 11. In the first position, the third fastener 284 is disposed at a first distance (not illustrated) measured relative to the second end 300B of the arm 214. The arm 14 transitions from a first position to a second position when the first and second release knobs 290, 292 are disengaged and move away from the right surface 306 of the arm 214 via the user asserting a rotational force in the counter-clockwise direction on each of the first and second release knobs 290, 292 to loosen the first and second release knobs 290, 292. Upon disengagement, the arm 14 linearly moves along the third and fourth fasteners 284, 288 and moves laterally away from rear end 200B of alignment device 200 and towards the front end 200A of alignment device 200 via the user asserting a pulling force on the arm 214 in a lateral direction towards the top end towards the front end 200A of alignment device 200 along the longitudinal axis “X”. As illustrated in FIG. 10, the third fastener 284 is disposed at a second distance “D₃” measured relative to the second end 300B of the arm 214. In the illustrated embodiment, the second distance “D₃” is less than the first distance.

As illustrated in FIGS. 9 through 11, the laser 216 has a first end 320A, a second end 320B that is opposite to the first end 320A, a longitudinal axis “X_{L}” that extends from the first end 320A to the second end 320B, and an attachment point (not illustrated) that is disposed between the first end 320A and the second end 320B of the laser 216 proximate to the first end 320A of the laser 216. In addition, the laser 216 may be powered in various ways to emit a laser beam “B,” where such details were described previously. In addition, such capabilities of the laser 216 emitting the laser B″ onto the lawn of grass “G” during operation of the lawn mower 1 by displaying a laser line “L” is similar to the capabilities of the laser 16 in alignment device 10.

As illustrated in FIG. 11, the alignment device 200 includes a fifth fastener 314. The opening 310 of the arm 214 and the attachment point of the laser 216 is sized and configured to receive the fifth fastener 314 to secure the arm 214 and the laser 216 to one another. The fifth fastener 314 passes through the opening 310 of the arm 214 and is disposed within attachment point of the laser 216. As illustrated in FIGS. 10 and 11, the laser 216 pivots on the fifth fastener 314 in which the laser 216 rotates about a first axis of rotation “Ri” defined by the fifth fastener 314 when the laser 216 is manipulated by the user. The rotation of the laser 216 on the fifth fastener 314 is illustrated by the arrows denoted 315 in FIGS. 10 and 11. The first axis of rotation “Ri” is disposed orthogonal to the longitudinal axis “X_{A}” of the arm 14 and is disposed parallel to the transverse axis “Y” of the alignment device 200 due to the placement of the fifth fastener 314. As illustrated in FIG. 10, the longitudinal axis “X_{L}” of the laser 216 is oriented at an angle A that is measured relative to the longitudinal axis “X_{A}” of the of the arm 214. Examples of suitable angles for an angle Δ of a longitudinal axis of a laser that is measured relative to a longitudinal axis of an arm include a range measured between about 10 degrees to about 45 degrees.

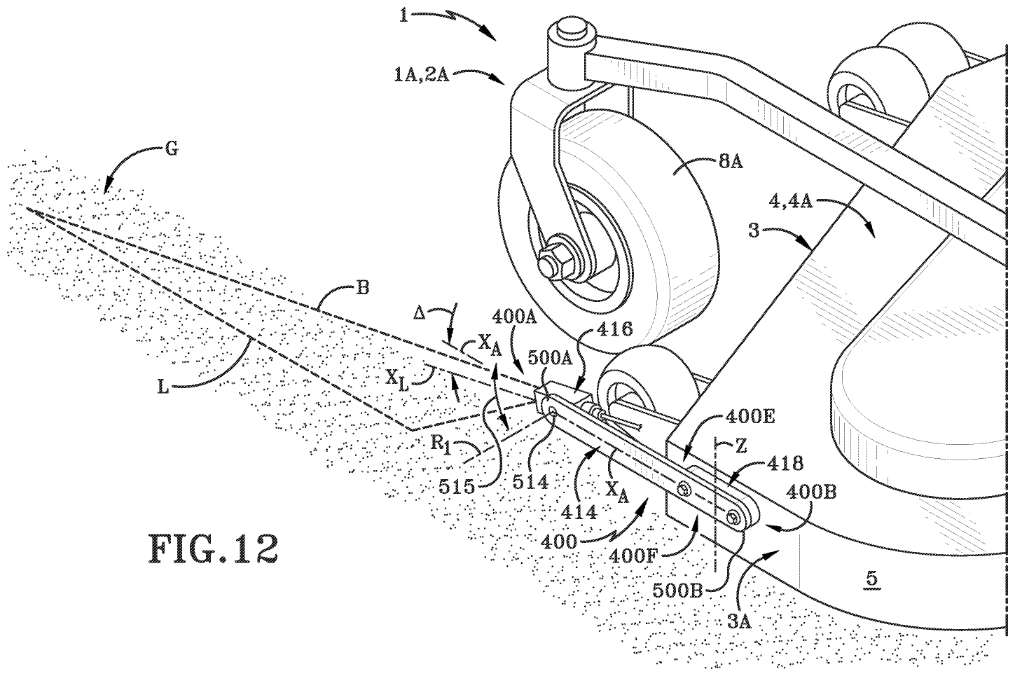

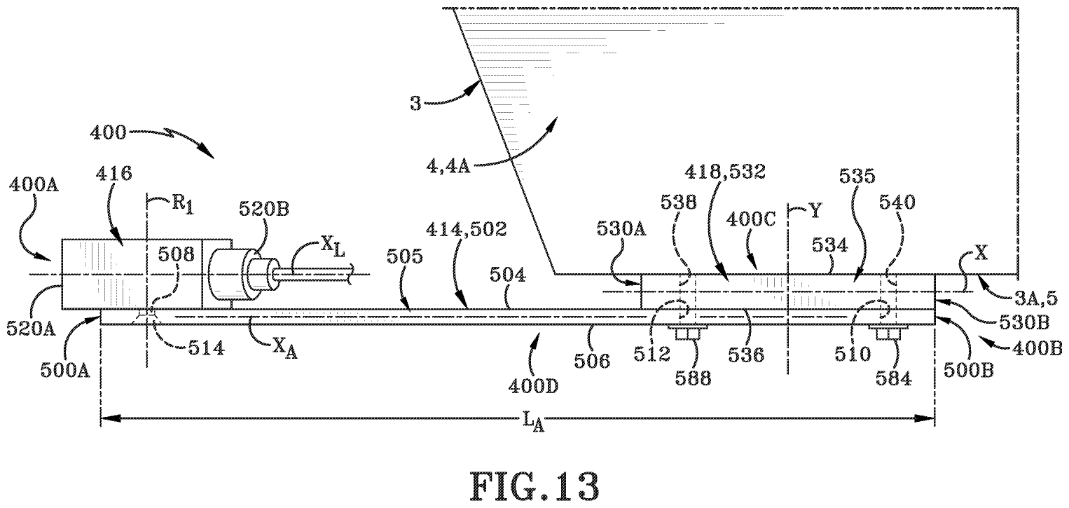

FIGS. 12 and 13 illustrate another alignment device 400 that is similar to alignment device 200 illustrated in FIGS. 9-11, except as detailed below. Alignment device 400 includes an arm 414, a laser 416 and a spacer 418.

Alignment device 400 generally has a front end 400A, a rear end 400B that opposes the front end 400A, a first side 400C, a second side 400D that opposes the first side 400C, a top end 400E (FIG. 12), and a bottom end 400F (FIG. 12) that opposes the top end 400E. Alignment device 400 defines a longitudinal axis “X” (FIG. 13) that extends from the front end 400A to the rear end 400B, a transverse axis “Y” that extends from the first side 400C to the second side 400D (FIG. 13), and a vertical axis “Z” (FIG. 12) that extends from the top end 400E to the bottom end 400F.

As illustrated in FIG. 13, the arm 414 has a first end 500A, a second end 500B directly opposite to the first end 500A, a longitudinal axis “X_{A}” that extends from the first end 500A and through the second end 500B, a main wall 502, an arm length “L_{A}” that extends between the first end 500A and the second end 500B, and a circumferential wall 505 disposed about the perimeter of the main wall 502 that extends between the first and second ends 500A, 500B. Each of the first end 500A and the second end 500B of the arm 414 includes rounded edges. The arm 414 has a left surface 504 that faces the first side 400C of the alignment device 400 and a right surface 506 that faces the second side 400D of the alignment device 400. The left surface 504 is parallel to the right surface 506 and they oppose one another.

The arm 414 of alignment device 400 is similar to the arm 214 of alignment device 200. However, the arm 414 defines first, second, and third openings 508, 510, 512 as compared to the slot 308 and opening 310 defined by the arm 212, which are shown in FIG. 12. The first opening 508 is defined between the first and second ends 500A, 500B of the arm 414 proximate to the first end 500A. The second opening 510 is defined between the first and second ends 500A, 500B of the arm 414 proximate to the second end 500B. The third opening 512 is defined between the first and second openings 508, 510 proximate to the second opening 510. Each of the first, second, and third openings 508, 510, 512 extends entirely through the arm 414 such that the left and right surfaces 504, 506 of the arm 414 are in communication at the first, second, and third openings 508, 510, 512.

As illustrated in FIGS. 12 and 13, the laser 416 has a first end 520A, a second end 520B that is opposite to the first end 520A, a longitudinal axis “X_{L}” that extends from the first end 520A to the second end 520B, and an attachment point (not illustrated) that is disposed between the first end 520A and the second end 520B of the laser 416 proximate to the first end 520A of the laser 416. In addition, the laser 416 may be powered in various ways to emit a laser beam “B,” where such details were described previously. In addition, such capabilities of the laser 416 emitting the laser “B” onto the lawn of grass “G” during operation of the lawn mower 1 by displaying a laser line “L” is similar to the capabilities of the laser 16 in alignment device 10.

As illustrated in FIG. 13, the alignment device 400 includes a first fastener 514. The first opening 508 of the arm 414 and the attachment point of the laser 416 is sized and configured to receive the first fastener 514 to secure the arm 414 and the laser 416 to one another. The first fastener 514 passes through the first opening 508 of the arm 414 and is disposed within attachment point of the laser 416. The laser 416 pivots on the first fastener 514 in which the laser 416 rotates about a first axis of rotation “R₁” defined by the first fastener 514 when the laser 416 is manipulated by the user. The rotation of the laser 416 on the first fastener 514 is illustrated by the arrows denoted 515 in FIG. 12. The first axis of rotation “R₁” is disposed orthogonal to the longitudinal axis “X_{A}” of the arm 414 and is disposed parallel to the transverse axis “Y” of the alignment device 400 due to the placement of the first fastener 514. As illustrated in FIG. 12, the longitudinal axis “X_{L}” of the laser 416 is oriented at an angle A that is measured relative to the longitudinal axis “X_{A}” of the of the arm 414. Examples of suitable angles for an angle A of a longitudinal axis of a laser that is measured relative to a longitudinal axis of an arm include a range measured between about 10 degrees to about 45 degrees.

As illustrated in FIG. 13, the spacer 418 has a first end 530A, a second end 530B directly opposite to the first end 530A, a main wall 532, and a circumferential wall 535 disposed about the perimeter of the main wall 532 that extends between the first and second ends 530A, 530B. The spacer 418 has a left surface 534 that faces the first side 400C of the alignment device 400 and a right surface 536 that faces the second side 400D of the alignment device 400. The left surface 534 is parallel to the right surface 536 and they oppose one another.

The spacer 418 defines first and second openings 538, 540. The first opening 538 is defined between the first and second ends 530A, 530B of the spacer 418 proximate to the first end 530A. The second opening 540 is defined between the first and second ends 530A, 530B of the spacer 418 proximate to the second end 530B. Each of the first and second openings 538, 540 extends entirely through the spacer 418 such that the left and right surfaces 534, 536 of the spacer 418 are in communication at the first and second openings 538, 540.

The second opening 540 of the spacer 418 and the second opening 510 of the arm 414 are sized and configured to receive a second fastener 584. The second fastener 584 secures the arm 414 and the spacer 418 to the sidewall 5 of the mower deck 3 at the closed end 3A via a first nut (not illustrated). Similarly, the first opening 538 of the spacer 418 and the third opening 512 of the arm 414 are sized and configured to receive a fourth fastener 588. The fourth fastener 588 secures the arm 414 and the spacer 418 to one another via a first nut (not illustrated) on the sidewall 5 of the mower deck 3 at the closed end 3A. Once the arm 414 and the spacer 418 are secured to the mower deck 3, the laser beam “B” emitted by the laser 416 is aligned with the sidewall 5 of the mower deck 3 at the closed end 3A.

In the illustrated embodiment, the arm 414 remains stationary on the spacer 418 such that the arm 414 does not provide any adjustments to the operator “OP” of the lawn mower 1. As such, the laser 416 is the only component of alignment device 400 that may move (i.e., rotate) for adjustment purposes. Such rotation of the laser 416 is similar to the rotation described in the laser 16 of the alignment device 10 and the laser 216 of the alignment device 200.

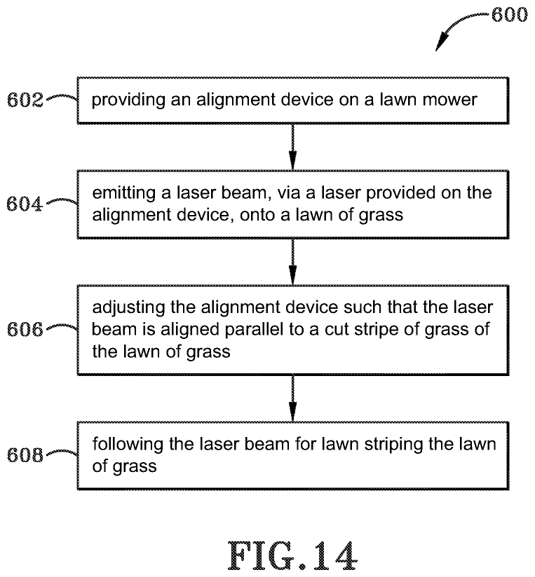

FIG. 14 illustrates a method 600 for improving alignment for lawn striping with an alignment device. The initial step 602 of method 400 comprises providing an alignment device on a lawn mower. Step 604 comprises emitting a laser beam, via a laser provided on the alignment device, onto a lawn of grass. Step 606 comprises adjusting the alignment device such that the laser beam is aligned parallel to a cut stripe of grass of the lawn of grass. Step 608 comprises following the laser beam for lawn striping the lawn of grass.

In an exemplary embodiment, method 600 may include additional steps for improving alignment for lawn striping with an alignment device. An optional step may comprise adjusting an arm of the alignment device to effectively emit the laser beam onto the lawn such that the laser beam is parallel to the cut stripe of grass; this optional step may be performed after step 604 and prior to step 606. Another optional step may comprise adjusting a mounting bracket of the alignment device to provides a suitable overlap between a cut grass portion and an uncut grass portion; this optional step may be performed prior to step 606 and may be repeated. In addition, step 608 may be performed prior to step 606. Another optional step may comprise aligning the laser beam with a sidewall of a mower deck provided on the lawn mower. Another optional step may comprise of adjusting the laser vertically relative to a vertical axis of the piece of landscaping equipment via the mounting assembly. Another optional step may comprise of adjusting the laser laterally relative to a longitudinal axis of the piece of landscaping equipment via the mounting assembly. Another optional step may comprise of adjusting the laser longitudinally relative to a longitudinal axis of the piece of landscaping equipment via the mounting assembly.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/-5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. In combination:
a piece of landscaping equipment moveable over a terrain;
a laser; and
a mounting assembly configured to engage the laser to the piece of landscaping equipment, wherein the laser is selectively operably to emit a laser beam across a portion of terrain that is located in front of the piece of landscaping equipment as the piece of landscaping equipment moves over the terrain.

2. The combination according to claim 1, wherein the mounting assembly is operable to adjust a position of the laser relative to the piece of landscaping equipment.

3. The combination according to claim 2, wherein the mounting assembly permits vertical adjustment of the laser relative to the piece of landscaping equipment.

4. The combination according to claim 2, wherein the mounting assembly permits lateral adjustment of the laser relative to a longitudinal axis of the piece of landscaping equipment, wherein the longitudinal axis extends between a front end and a rear end of the piece of landscaping equipment.

5. The combination according to claim 2, wherein the mounting assembly permits longitudinal adjustment of the laser relative to a longitudinal axis of the piece of landscaping equipment, wherein the longitudinal axis extends between a front end and a rear end of the piece of landscaping equipment.

6. The combination according to claim 1, wherein the piece of landscaping equipment is a zero-turn lawn mower.

7. The combination according to claim 6, wherein the mounting assembly secures the laser to a mower deck provided on the zero-turn lawn mower.

8. The combination according to claim 6, wherein the mounting assembly secures the laser to a main body of the zero-turn lawn mower that is disposed above the mower deck.

9. The combination according to claim 1, wherein the mounting assembly has a mounting bracket and an arm, wherein the arm is moveably disposed on the mounting bracket, and wherein the laser is moveably disposed on the arm.

10. The combination according to claim 9, a mounting bracket has a wall that defines a first portion and a second portion;
wherein the first portion and the second portion are operably engaged at a bend formed in the wall of the bracket.

11. The combination according to claim 10, wherein the first portion is disposed on the piece of landscaping equipment; and
wherein the first portion is selectively adjustable on the piece of landscaping equipment for adjusting the laser relative to the piece of landscaping equipment.

12. The combination according to claim 10, wherein the second portion and the arm operably engage to one another; and
wherein the arm is selectively adjustable on the second portion for adjusting the laser relative to the piece of landscaping equipment.

13. The combination according to claim 12, wherein the second portion permits vertical adjustment of the arm relative to the second portion.

14. The combination according to claim 12, wherein the second portion permits longitudinal adjustment of the arm relative to the second portion.

15. The combination according to claim 9, wherein the arm permits rotational adjustment of the laser relative to the arm.

16. A method for improving alignment for lawn striping, the method comprising:
providing an alignment device on a piece of landscaping equipment, emitting a laser beam, via a laser provided on the alignment device, onto a lawn of grass;
adjusting the laser such that the laser beam is aligned parallel to a cut stripe of grass of the lawn of grass; and
following the laser beam for lawn striping the lawn of grass.

17. The method of claim 16, further comprising;
aligning the laser beam with a sidewall of a mower deck provided on the lawn mower.

18. The method of claim 16, further comprising:
adjusting the laser vertically relative to a vertical axis of the piece of landscaping equipment via a mounting assembly.

19. The method of claim 16, further comprising:
adjusting the laser laterally relative to a longitudinal axis of the piece of landscaping equipment via a mounting assembly.

20. The method of claim 16, further comprising:
adjusting the laser longitudinally relative to a longitudinal axis of the piece of landscaping equipment via a mounting assembly.
